(19) United States
(12) Patent Application Publication
(10) Pub. No.: US 2010/0021734 A1
(43) Pub. Date: Jan. 28, 2010

(54) CERAMIC PARTICLES AND PRODUCING METHOD THEREOF

(75) Inventors: Hideo Uemoto, Kanagawa (JP); Tomoki Sugino, Kanagawa (JP); Hiroyuki Goto, Kanagawa (JP); Taikei Yasumoto, Kanagawa (JP)

Correspondence Address: FOLEY AND LARDNER LLP;SUITE 500, 3000 K STREET NW, WASHINGTON, DC, 20007, US

(73) Assignee: COVALENT MATERIALS CORPORATION

(21) Appl. No.: 12/507,172

(22) Filed: Jul. 22, 2009

(30) Foreign Application Priority Data
Jul. 22, 2008 (JP) 2008-188675
Sep. 29, 2008 (JP) 2008-251238
Oct. 27, 2008 (JP) 2008-275836
Jun. 17, 2009 (JP) 2009-144502

(51) Int. Cl. C04B 38/00; B32B 5/16

(52) U.S. Cl. 428/402; 501/80

(57) ABSTRACT

Ceramic particles capable of increasing the reaction area with an eluate, etc. without decreasing the diameter of the particle per se and a producing method thereof are provided. A ceramic particles 10 of the present invention has an average particle diameter of 5 μm or more and 5 mm or less and a plurality of open pores formed at the outer surface, and has two pore size distributions in the measurement by a mercury porosimeter, in which the two pore size distributions includes a first pore size distribution having a peak within a range of 300 nm or more and 20 μm or less and a second pore size distribution having a peak in a range of 200 nm or less.

### BACKGROUND OF THE INVENTION

1. Field of the Invention

The present invention relates to a ceramic particle and a producing method thereof.

2. Brief Description of the Background Art

Since ceramic particles have an excellent property of adsorbing catalysts, cells, proteins, etc., they are used generally, for example, as catalyst supports, cell culture supports, and fillers for liquid chromatography.

The ceramic particles are required to have high specific surface area for improving reactivity with other materials.

For such requirements, it has been disclosed, for example, porous calcium phosphate type compound particles of spherical shapes with an average particle size of from 1 to 40 μm which has continuous pores with an average pore size of from 100 to 4000 Å, in which fine pores having a pore size in a range from 0.5 to 2 times the average pore size occupy 70% or more of the entire fine pore volume and the fine pore volume per 1 g of particles is 0.05 ml or more; and which comprises calcium phosphate type compound at a Ca/P ratio of from 1.5 to 1.80 (for example, claim 1 in JP-08-32551B etc.).

Furthermore, for obtaining a high specific surface area, a technique of reducing the diameter of the particles itself is also known generally.

### SUMMARY OF THE INVENTION

However, since it is difficult that eluate or gas (hereinafter referred to as eluate, etc.) flows into the inside of the continuous pores having the average pore size as described in JP-08-32551B, a part having a substantial reactivity may be limited to only at the outer surface of the ceramic particle. Accordingly, the reaction area with the eluate, etc. cannot be increased and there is a limit on the improvement of separation property.

Furthermore, the technique of reducing the diameter of the particle itself for obtaining a high specific surface area involves a problem, for example, that pressure loss increases when particles of reduced diameter are packed in a column, since the flow resistance of the eluate, etc. sent to the column is increased to increase the load on the apparatus.

The ceramic particle according to the present invention is a ceramic particle having an average particle diameter of 5 μm or more and 5 mm or less, in which a plurality of open pores are formed at the outer surface, wherein the ceramic particle has two pore size distributions in the measurement by a mercury porosimeter. Specifically, the two pore size distributions include a first pore size distribution having a peak within a range of 300 nm or more and 20 μm or less and a second pore size distribution having a peak within a range of from 200 nm or less.

### BRIEF DESCRIPTION OF THE DRAWINGS

FIG. 1 is a schematic view for the appearance of a ceramic particle according to the present embodiment.

FIG. 2 is a schematic view for the cross section from the surface to the inside of a ceramic particle of the present embodiment.

FIG. 3 is a schematic view of steps for explaining the method of producing ceramic particles of the present embodiment.

FIG. 4 shows a SEM photograph for a ceramic particle produced in Example 1.

FIG. 5 shows analysis for a ceramic particle produced in Example 1 by a mercury porosimeter.

FIG. 6 shows a SEM photograph for a ceramic particle produced in Comparative Examples 1-3.

FIG. 7 shows analysis for a ceramic particle produced in Comparative Examples 1-3 by a mercury porosimeter.

FIG. 8 shows the result of evaluation for separation property in Example 7.

FIG. 9 shows the result of evaluation for separation property in Comparative Example 4.

FIG. 10 shows the result of evaluation for separation property in Comparative Example 5.

FIG. 11 shows the result of evaluation for separation property in Comparative Example 6.

FIG. 12 shows a SEM photograph for a ceramic particle produced in Example 7 before classification to an average particle size of 80 μm.

The followings are description for reference numerals in the drawings.
10 . . . ceramic particle
10a . . . outer surface
20 . . . open pore (the first open pore)
20a . . . surface open pore
20b . . . inner open pore
20c . . . inner open pore

### DETAILED DESCRIPTION OF THE INVENTION

The present invention has been achieved in view of the situations described above and it intends to provide a ceramic particle capable of increasing the reaction area with the eluate, etc. and a production method thereof.

In the ceramic particle of the embodiment of the present invention, the reaction area with the eluate, etc. can be increased without reducing the size of the particle itself by the constitution described above.

Additionally, the ceramic particle according to the present invention is a ceramic particle in which a plural number of open pores are formed at the outer surface wherein the open pore has a first open pore formed at the outer surface with an average pore size of 1 μm or more and 50 μm or less and a second open pore formed in communication with the inner wall surface of the first open pore with an average pore size of 1 μm or more and 50 μm or less; the pore size for the opening part of the first open pore on the side of the outer surface and the pore size for the communication part between the first open pore and the second open pore is 500 nm or more and 30 μm or less; and the skeleton part which forms the open pore comprises a porous body.

Since the eluate, etc. flows to the inside of the ceramic particle with the constitution described above, the reaction area with the eluate, etc. can be further increased.

The open pore is preferably formed from one outer surface in communication with the other outer surface of the ceramic particle.

Since the eluate, etc. can flow uniformly to the inside of the ceramic particle due to the constitution described above, the reaction area with the eluate, etc. can be maximized.

The ceramic particle comprises one of inorganic oxides such as alumina, silica, mullite, zirconia, and calcium phosphate, silicon carbide, boron carbide and silicon nitride.

Due to the constitution described above, the ceramic particle according to the present invention can be used generally for catalyst supports, cell culture supports, fillers for liquid chromatography, etc.

Furthermore, a method of producing a ceramic particle according to the present invention including a step of: adding a first oil and a hydrophilic surfactant to a slurry (W) containing a ceramic powder, a binder, a dispersant, and pure water and providing shear stress to the first oil to form an oil droplet particle (O) comprising the first oil, in order to prepare an O/W emulsion in which the oil droplet particles (O) are dispersed in the slurry (W); a step of adding the O/W emulsion to a second oil (O) containing an oleophilic surfactant and providing shear stress to the O/W emulsion to form a fine liquid droplet (O/W) comprising a slurry in which the oil droplet particles (O) are confined in the inside thereof in order to prepare an O/W/O emulsion in which the fine liquid droplets (O/W) are dispersed in the second oil (O); and a step of baking the fine liquid droplet (O/W).

The ceramic particle according to the present invention described above can be produced by the production method described above.

A preferable embodiment of the present invention is described specifically in below.

### The First Embodiment

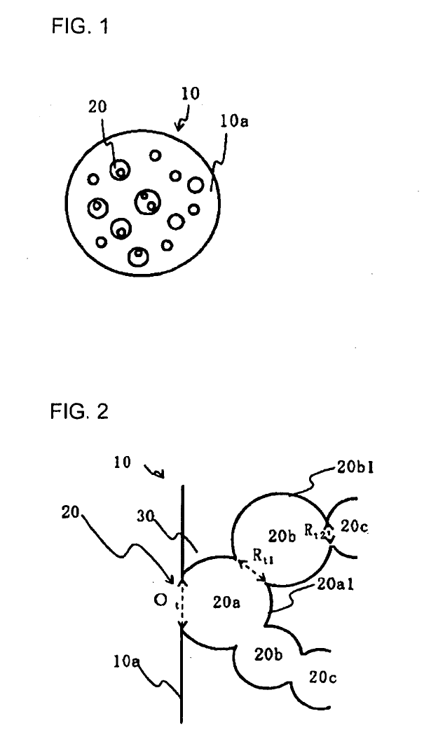

FIG. 1 shows a schematic view for the appearance of the ceramic particle according to the present embodiment and FIG. 2 shows a schematic view for the cross section from the surface to the inside of the ceramic particle according to the present embodiment, respectively.

As shown in FIG. 1, the ceramic particle 10 of the present embodiment has a plurality of first open pores 20 at the outer surface 10a and, further, has a plurality of second open pores (not illustrated) with a pore size of smaller than that of the first open pore 20 at the outer surface 10a and the surface of the skeleton part 30 constituting the first open pore 20.

The first open pore is formed by a spherical pore. The skeleton part constituting the spherical open pore, namely, the second open pore is formed of a non-spherical porous body. The spherical shape referred to herein is not limited to a truly spherical shape but also includes, for example, a shape somewhat flattened or distorted from the true spherical shape. The non-spherical shape means those other than the spherical shape described above.

As shown in FIG. 2, the first open pore 20 has a first open pore 20a formed at the outer surface 10a, an inner open pore 20b formed in communication with the inner wall surface 20a1 of the surface open pore 20a, and an inner open pore 20c, - - - formed in communication with the inner wall surface 20b1 of the inner open pore 20b.

Specifically, in the ceramics particle 10 of present embodiment, the peak in the pore size distribution due to the pore size Oₜ for the opening on the side of the outer surface 10a of the surface open pore 20a, the pore size Rₜ₁ for the communication part that communicates the surface open pore 20a and the inner open pore 20b, and the pore size Rₜ₂ for the communicating part that communicates between the inner open pores (between 20b and 20c in FIG. 2) (hereinafter referred to as a peak in the open pore distribution due to the first open pore) is 300 nm or more and 20 μm or less. Furthermore, the peak in the pore size distribution of the pore size for the opening part of the outer surface 10a constituting the second open pore (not illustrated), the pore size for the opening part of the first open pore 20 (not illustrated), and the pore size for the communication part that communicates between the second open pores (not illustrated) (hereinafter referred to as the peak in the pore size distribution due the second open pore) is 200 nm or less.

As described above, since the ceramic particle 10 of the present embodiment has a plurality of the open pores as described above and, accordingly, can react with an eluate, etc. not only at the outer surface but also at the surface of the skeleton part constituting the open pore by the flow of the eluate, etc. into the open pore, the reaction area with the eluate, etc. can be increased without decreasing the diameter of the particle per se.

In a case where the peak in the pore size distribution due to the first open pore is less than 300 nm, since the pore size Oₜ for the opening part on the side of the outer surface 10a is decreased and the eluate, etc. less flows into the open pore 20, it is difficult to increase the reaction area with the eluate, etc. Furthermore, in a case where the peak in the pore size distribution due to the first open pore exceeds 20 μm, since the pore size Rₜ₁, Rₜ₂ for the opening part is increased and the strength of the ceramic particle 10 per se is lowered, it is not preferable. Furthermore, since lowering of the strength of the ceramic particle 10 per se induces breakage of the ceramic particle 10, which brings about decrease in the diameter of the ceramic particle, a problem of increasing the pressure loss as a result is caused.

In a case where the peak in the pore size distribution due to the second open pore exceeds 200 nm, it is not preferable since the reactivity with the eluate, etc. is lowered by decrease in the specific surface area.

The first open pore 20 is preferably formed through the ceramic particle 10 from one outer surface to the other outer surface.

With such constitution, since the eluate, etc. can flow uniformly to the inside of the ceramic particle, the reaction area with the eluate, etc. can be maximized.

The peak in the pore size distribution is a value measured by a mercury penetration method using a mercury porosimeter.

The particle diameter of the ceramic particle 10 of the present embodiment is not particularly limited so long as the open pore is formed in plurality and has such a size as capable of maintaining the strength as the ceramic particle 10. The particle diameter (average particle diameter) of the ceramic particle 10 of the present embodiment is, for example, 5 μm or more and 5 mm or less.

The ceramic particle 10 of the present embodiment described above preferably comprises any one of inorganic oxides such as alumina, silica, mullite, zirconia, calcium phosphate, and titanium oxide, silicon carbide, boron carbide, and silicon nitride.

With such a constitution, the ceramic particle of the present invention can be used generally, for example, as a catalyst carrier, a cell cultivation carrier, a filler for liquid chromatography, etc.

Among them, since calcium phosphate has high adsorption ability to proteins, etc., it is suitably used as the filler for liquid chromatography such as HPLC (High Performance Liquid Chromatography) and a higher effect as a filler can be obtained by using the ceramic particle 10 of the constitution described above. As the calcium phosphate referred to herein, any calcium phosphate at a Ca/P ratio of 1.5 to 1.8 can be used and includes, for example, tricalcium phosphate, hydroxyapatite, and fluoroapatite. Furthermore, in a case of constituting the ceramic particle 10 of the present invention with calcium phosphate and using the particle as the filler, the ceramic particle 10 preferably has a specific surface area of 10 m²/g or more. For this purpose, calcium phosphate used as the raw material preferably has a specific surface area of 50 m²/g or more also in view of increasing the strength after calcination in the producing method to be described later.

As described above, it is necessary that the skeleton part 30 constituting the first open pore 20 is formed of the porous body. The specific surface area for the material constituting the skeleton part 30 is, for example, 5 m²/g or more and 60 m²/g or less.

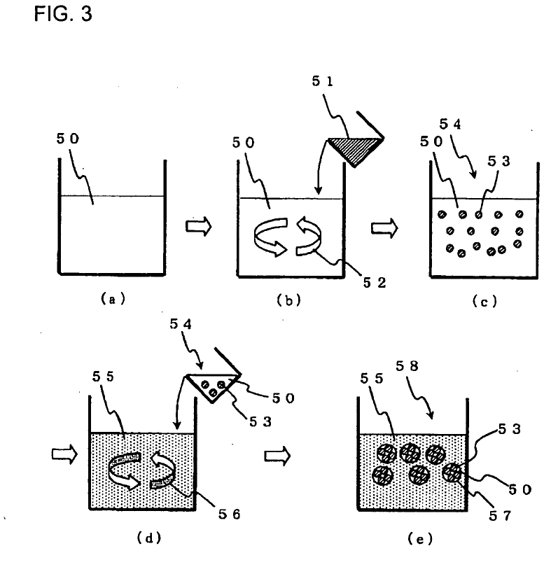

Then, a producing method of the ceramic particle 10 according to the present embodiment is to be described with reference to the drawings. FIG. 3 is a schematic view of steps for explaining the producing method of the ceramic particle of the present embodiment.

At first, a slurry (W) 50 containing a ceramic powder, a binder, a dispersant, and pure water is prepared (FIG. 3(a)).

The ceramic powder used herein is a powder of any one of inorganic oxides such as alumina, silica, mullite, zirconia, calcium phosphate and titanium oxide, silicon carbide, boron carbide, and silicon nitride. Furthermore, for the binder used herein, agar can be used preferably. For the dispersant used herein, ammonium polyacrylate can be used, for example. Pure water referred to herein is pure water used generally in the field of semiconductor production which is formed generally from industrial water, tap water, etc. as raw water by separating impurities contained therein for purification by using, for example, a highly pure ion exchange resin, a high functional membrane, a deaerating device, etc. For example, the pure water means those purified, for example, to a specific resistivity of 1 MΩ·cm or higher compared with domestic tap water of 0.01 to 0.05 MΩ·cm.

Then, a first oil 51 and a hydrophobic surfactant (not illustrated) are added to the slurry (W) 50 to provide the first oil 51 with a shear stress 52 (FIG. 3(b)).

As the first oil 51 used herein, normal paraffin, isoparaffin, hexadecane, etc. can be used preferably. Furthermore, for the hydrophilic surfactant, polyoxyethylene sorbitan monooleate can be used preferably. Furthermore, the shear stress 52 can be provided by a stirrer.

As described above, by providing the shear stress 52 to the first oil 51, oil droplets (O) 53 comprising the first oil 51 are formed to prepare an O/W emulsion 54 in which the oil droplets (O) 53 are dispersed in the slurry (W) 50 (FIG. 3(c)).

Then, a second oil (O) 55 containing an oleophilic surfactant is prepared. The O/W emulsion 54 prepared as described above is added to the second oil (O) 55 and a shear stress 56 is provided to the O/W emulsion 54 (FIG. 3(d)).

For the second oil 55 used herein, normal paraffin, isoparaffin, hexadecane, etc. can be used suitably. Furthermore, for the oleophilic surfactant, sorbitan sesquioleate can be used suitably. Furthermore, the shear stress 56 can be provided by a stirrer.

By providing the O/W emulsion 54 with the shear stress 56 as described above, a fine liquid droplet (O/W) 57 comprising a slurry 50 containing the oil droplet particles (O) 53 therein is formed, and an O/W/O emulsion 58 containing fine droplets (O/W) 57 dispersed in the second oil (O) 55 is prepared (FIG. 3(e)).

Finally, when the fine liquid droplets (O/W) 57 are recovered from the O/W/O emulsion 58 and the fine liquid droplets (O/W) 57 are calcinated, the slurry (W) 50 in the fine liquid droplets (O/W) 57 is calcinated and the oil droplet particles (O) 53 are evaporated, by which the ceramic particle 10 according to the invention having the open pore 20 formed from the part of the oil droplet particle (O) 53 can be produced.

The pore sizes Oₜ, Rₜ₁, Rₜ₂ can be controlled according to the amount of use for the first oil 51, the kind and the amount of use for the hydrophilic surfactant, the intensity of the shear stress 52, etc.

Furthermore, the porosity of the porous body in the skeleton part 30 can be controlled by the particle diameter, the calcinations temperature of the raw material used as the ceramic powder, etc.

Furthermore, in the step of producing the ceramic particle 10, in a case of using agar as the binder, the step is preferably performed under a heating circumstance, (for example, at 40° C. or higher) from the preparation of the slurry (W) 50 to the formation of the fine liquid droplets (O/W) 57. This can efficiently form the fine liquid droplets (O/W) 57 with no solidification of agar.

Furthermore, it is preferable to provide a step of cooling the O/W/O emulsion 58 after formation of the fine liquid droplets (O/W) 57 and before recovery of the fine liquid droplets (O/W) 57 from the (O/W/O) emulsion 58. Since agar contained in the fine liquid droplet (O/W) 57 is solidified after forming the fine liquid droplet (O/W) 57 and the entire fine liquid droplets (O/W) 57 are gelled by this step, this provides an effect of stabilizing the shape.

Furthermore, the gelled fine liquid droplets (O/W) 57 are preferably cleaned by using a solvent such as ethanol after the recovery and before the calcination. It removes the surfactant ingredient contained in the fine liquid droplets (O/W) 57 and water contained in the fine liquid droplets (O/W) 57 is replaced with the solvent. Since this can evaporate the substitution solvent ingredient in an early stage during calcination, the gelled fine liquid droplet (O/W) 57 can be calcinated with shape thereof being kept stable as it is.

Furthermore, a drying treatment may also be applied after cleaning with the solvent and before calcination. The drying treatment is carried out, for example, by vacuum drying under a reduced pressure. Since it removes the solvent ingredient before calcination, calcination can be carried out while keeping the shape of the fine liquid droplet (O/W) 57 stable as it is.

Furthermore, a film deposition treatment of depositing an oily ingredient to the gelled fine liquid droplets (O/W) 57 may also be carried out after cleaning with the solvent and before the drying treatment. With the film deposition treatment as described above, calcination can be carried out further while keeping the shape of the fine liquid droplet (O/W) 57 stable as it is. For the oily ingredient, normal paraffin, isoparaffin, hexadecane, etc. can be used suitably.

The ceramic particle 10 of the present embodiment can be produced also by preparing the O/W emulsion 54 by the method described above and granulating the O/W emulsion 54 by spray drying to form a granulated powder, followed by calcining the granulated powder.

### The Second Embodiment

FIG. 1 shows a schematic view for the appearance of a ceramic particle according to the present embodiment, and FIG. 2 shows a schematic view for a cross section from the surface to the inside of a ceramic particle according to the present embodiment, respectively.

The ceramic particle 10 of the present embodiment has a plural number of open pores 20 at an outer surface 10a as shown in FIG. 1.

As shown in FIG. 2, the open pore 20 which corresponds to the first open pore in the second embodiment has a surface open pore 20a formed at the outer surface 10a and having an outer pore size of 500 nm or more and 50 μm or less in which the pore size O₁ of the opening part of the surface open pore 20a on the side of the outer surface 10a is 300 nm or more and 20 μm or less.

Since the eluate, etc. flows to the inside of the surface open pore 20a of the ceramic particle 10 due to constitution described above, the reaction area with the eluate, etc. can be increased without reducing the size of the particle itself in the ceramic particle of this embodiment.

In a case where the average pore size is less than 500 nm, since the pore size of the opening part is sometimes less than 300 nm and the eluate, etc. less flows into the surface open pore, it is difficult to increase the reaction area with the eluate, etc. and there is a limit on the improvement of the separation property. Furthermore, in a case where the average pore size is more than 50 μm, the pore size of the opening part is sometimes more than 20 μm and the strength of the ceramic particle 10 itself may possibly be lowered, which is not preferable. Lowering of the strength of the ceramic particle 10 itself results in a problem that the destruction of the ceramic particle 10 is induced. Additionally, since this reduces the size of the ceramic particles, the pressure loss is increased as a result.

The open pore 20 (first open pore), as shown in FIG. 2, at least has a surface open pore 20a formed at the outer surface 10a and having an average pore size of 500 nm or more and 50 μm or less and an inner open pore 20b formed in communication with the inner wall surface 20a1 of the surface open pore 20a and having an average pore size of 500 nm or more and 50 μm or less. It is preferable that the pore size Oₜ for the opening part of the surface open pore 20a on the side of the outer surface 10a and the pore size Rₜ₁ for the communication part between the surface open pore 20a and the inner open pore 20b is 300 nm or more and 20 μm or less.

Since the eluate, etc. flow into the inside of the ceramic particle 10 (inner open pore 20b) due to the structure described above, the reaction area with the eluate, etc. can be further increased.

It is more preferable that the open pore 20 is formed from one outer surface in communication with the other outer surface of the ceramic particle 10. Namely, it is preferable that a plural number of surface open pores 20a and inner open pores 20b, 20c - - - are formed from one outer surface in communication with the other outer surface of the ceramic particle 10 as shown by the second inner open pore 20c formed in communication with the inner wall surface 20b1 of the inner open pore 20b and having an average pore size of 500 nm or more and 50 μm or less as shown in FIG. 2. Also in this case, the pore size Rₜ₂ for the communication part between the inner open pores 20b and 20c is preferably from 300 nm or more and 20 μm or less in the same manner as above.

Since the eluate, etc. can be flown uniformly to the inside of the ceramic particle due to the structure described above, the reaction area with the eluate, etc. can be maximized.

The surface open pore and the inner open pore are formed of spherical pores. The skeleton part constituting the spherical open pore (corresponding to the second open pore in the first embodiment) is formed of a non-spherical porous body. The spherical shape is not limited to a truly spherical shape and also include, for example, shape somewhat flattened or distorted from the truly spherical shape. The non-spherical shape means those other than the spherical shape described above.

The average pore size is a value obtained by an electromicroscopic observation and image diffraction for a resin-embedded ceramic particle polished at the surface. Further, the pore sizes Oₜ, Rₜ₁, and Rₜ₂ are measured by a mercury penetration method using a mercury porosimeter.

The particle size of the ceramic particle 10 according to the present embodiment described above is not particularly limited so long as a plural number of the open pores 20 are formed and the particle has such a size as capable of keeping the strength as the ceramic particle 10. The particle size of the ceramic particle 10 according to this embodiment is, for example, 10 μm or more and 200 μm or less.

The ceramic particle 10 according to the embodiment described above preferably comprises one of inorganic oxides such as alumina, silica, mullite, zirconium, and calcium phosphate, silicon carbide, boron carbide, and silicon nitride.

Due to the constitution as described above, the ceramic particle according to the present invention can be used generally, for example, for catalyst supports, cell culture supports, fillers for liquid chromatography, etc.

Among them, calcium phosphate is used most suitably as the filler for liquid chromatography such as HPLC (High Performance Liquid Chromatography) because of its high adsorption property to proteins, etc. A high effect as the filler can be obtained by using the ceramic particle 10 of the structure described above. As the calcium phosphate referred to herein, any calcium phosphate with the Ca/P ratio from 1.5 to 1.8 can be used and includes tricalcium phosphate, hydroxyl apatite, and fluoroapatite. In a case where the ceramic particle 10 of the present invention comprises calcium phosphate and is used as the filler, the ceramic particle 10 preferably has a specific surface area of 10 m²/g or more. For this purpose, the calcium phosphate used as the raw material preferably has a specific surface area of 50 m²/g or more also for improving the strength after baking in the production method to described later.

It is necessary that the skeleton part 30 which forms the open pore 20 comprises a porous body. The specific surface area of the material forming the skeleton part 30 is, for example, 5 m²/g or more and 60 m²/g or less.

Then, a method of producing a ceramic particle 10 according to the present embodiment is described with reference to the drawings. FIG. 3 is a schematic view of steps for explaining the method of manufacturing the ceramic particle according to the present embodiment.

At first, a slurry (W) 50 containing a ceramic powder, a binder, a dispersant, and pure water is prepared (FIG. 3(a)).

For the ceramic powder used herein, a powder of one of inorganic oxides such as alumina, silica, mullite, zirconia, and calcium phosphate, silicon carbide, boron carbide, or silicon nitride is used. As the binder used herein, agar can be used suitably. Furthermore, as the dispersant used herein, ammonium polyacrylate, etc. can be used. Pure water referred to herein is water used generally in the field of semiconductor production, which is prepared from industrial water, tap water, etc. as raw water and by purifying and separating impurities contained therein by using a highly pure ion exchange resin, a high function film, a deaeration device, etc. and which means water purified to a level, for example, of 1 MΩ·cm or higher as the specific resistivity compared with 0.01 to 0.05 MΩ·cm of tap water for home use.

Then, a first oil 51 and a hydrophilic surfactant (not illustrated) are added to the slurry (W) 50 and shear stress 52 is given to the first oil 51 (FIG. 3(b)).

As the first oil 51 used herein, normal paraffin, isoparaffin, hexadecane, etc. can be used suitably. Additionally, as the hydrophilic surfactant, polyoxyethylene sorbitan monooleate can be used suitably. Furthermore, the shear stress 52 can be provided by a stirrer.

As described above, by providing the shear stress 52 to the first oil 51, oil droplets (O) 53 comprising the first oil 51 are formed to prepare an O/W emulsion 54 in which the oil droplets (O) 53 are dispersed in the slurry (W) 50 (FIG. 3(c)).

Then, a second oil (O) 55 containing a hydrophilic surfactant is prepared. The O/W emulsion 54 prepared as described above is added to the second oil (O) 55 and a shear stress 56 is provided to the O/W emulsion 54 (FIG. 3(d)).

As the second oil 55 used herein, normal paraffin, isoparaffin, hexadecane, etc. can be used suitably. As the oleophilic surfactant, sorbitan sesquioleate can be used suitably. Furthermore, the shear stress 56 can be provided by a stirrer.

By providing the shear stress 56 to the O/W emulsion 54, a fine liquid droplet (O/W) 57 comprising a slurry 50 in which the oil droplet particle (O) 53 is confined is formed, followed by preparing an O/W/O emulsion 58 in which the fine droplets (O/W) 57 are dispersed in the second oil (O) 55 (FIG. 3(e)).

Finally, by recovering the fine liquid droplets (O/W) 57 from the O/W/o emulsion 58 and baking the fine liquid droplets (O/W) 57, the slurry (W) 50 in the fine liquid droplets (O/W) 57 is baked, and the oil droplet particle (O) 53 is evaporated, by which the ceramic particle 10 according to the present invention in which the open pore 20 is formed from the part of the oil droplet particle (O) 53 can be produced.

The average pore size and the opening sizes Oₜ, Rₜ₁, and Rₜ₂ of the open pore 20 can be controlled, for example, depending on the amount of the first oil 51 to be used, the type and the amount of use of the hydrophilic surfactant, the intensity of the shear stress 52, etc.

Additionally, the porosity of the porous body in the skeleton part 30 can be controlled, for example, by the particle size and the baking temperature of the raw material used as the ceramic powder.

Furthermore, in the step of producing the ceramic particle 10, in a case of using agar as a binder, it is preferably produced under a heated circumstance (for example, at 40° C. or higher) from the production of the slurry (W) 50 to the formation of the fine liquid droplets (O/W) 57. This can efficiently form the fine liquid droplets (O/W) 57 with no solidification of agar.

Furthermore, it is preferable to provide a step of cooling the O/W/O emulsion 58 after formation of the fine liquid droplet (O/W) 57 and before recovery of the fine liquid droplets 57 from the (O/W/O) emulsion 58. Since agar contained in the fine liquid droplet (O/W) 57 is solidified after forming the fine liquid droplet (O/W) 57 and the entire fine liquid droplets (O/W) 57 is gelled, which provides an effect of stabilizing the shape.

Furthermore, it is preferable to clean the gelled fine liquid droplet (O/W) 57 by using a solvent such as ethanol after the recovery and before the baking. It removes the surfactant ingredient contained in the fine liquid droplet (O/W) 57 and replaces the water content contained in the fine liquid droplet (O/W) 57 with the solvent. Since this can evaporate the substitution solvent ingredient in an early stage during baking, the gelled liquid droplet (O/W) 57 can be baked with the shape thereof which is kept stable.

Furthermore, a drying treatment may also be applied after cleaning with the solvent before baking. The drying treatment is performed, for example, by vacuum drying under a reduced pressure. Since it removes the solvent ingredient before baking, baking can be performed while the shape of the fine liquid droplet (O/W) 57 is kept stable.

Furthermore, a film deposition treatment of depositing an oily ingredient to the gelled fine liquid droplet (O/W) 57 may also be performed after cleaning with the solvent and before the drying treatment. With the film deposition treatment described above, baking can be performed while the shape of the fine liquid droplet (O/W) 57 is kept further stable as it is. For the oily ingredient, normal paraffin, isoparaffin, hexadecane, etc. can be used suitably.

The ceramic particle 10 according to the present embodiment can be produced also by preparing the O/W emulsion 54 by the method described above, then granulating the O/W emulsion 54 by spray drying to form a granulated powder, followed by baking the pelleted powder.

The present invention provides a ceramic particle capable of increasing the reaction area with an eluate, etc. without reducing the size of the particle itself, and a production method thereof.

### EXAMPLES

Although the followings will describe the present invention further in detail with reference to Examples, the present invention is not limited thereto.

An example according to the first embodiment is described specifically.

### Example 1

To an aqueous agar solution formed by adding agar to pure water at a 0.5% weight ratio, a hydroxyapatite powder was mixed at a 30% weight ratio based on the aqueous agar solution, and ammonium polyacrylate was added as a dispersant at a 5% weight ratio based on the hydroxyapatite powder. They were mixed in a ball mill for 10 hours or more to prepare a slurry containing hydroxyapatite.

Then, polyoxyethylene sorbitan monooleate was added at 1% based on pure water and isoparaffin at was added at 30% based on pure water, respectively to the obtained slurry, and they were stirred by using a stirrer. Isoparaffin was emulsified in the slurry by the stirring to form oil droplet particles, and an apatite slurry in which the oil droplet particles were dispersed was prepared.

Then, isoparaffin and a surfactant (Sorbian sesquioleate: at 4% weight ratio based on isoparaffin) were added in a beaker; stirred by using a stirrer under heating; and the apatite slurry prepared as described above containing the oil droplet particles dispersed therein was added little by little in the stirred state into the beaker. By the stirring, fine liquid droplets comprising a slurry confining the oil droplet particles in the inside were formed in the beaker.

The treatments so far were carried out under a circumstance of keeping the temperature at 40° C. or higher so that agar as the binder was not hardened.

Then, the beaker was cooled to cause gelling the fine liquid droplets formed as described above. Then, the gelled fine liquid droplets were recovered and, after solvent cleaning with ethanol, vacuum-dried under a reduced pressure, followed by a calcination treatment at 700° C.

The obtained ceramic particles were classified into an average particle diameter of 80 μm as a sample of Example 1.

### Comparative Examples 1 to 3

To an aqueous agar solution formed by adding agar to pure water at a 0.5% weight ratio, a hydroxyapatite powder was mixed at a 30% weight ratio based on the aqueous agar solution, and ammonium polyacrylate was added as a dispersant at a 5% weight ratio based on the hydroxyapatite powder. They were mixed in a ball mill for 10 hours or more to prepare a slurry containing hydroxyapatite.

Then, without forming the oil droplet particle as shown in Example 1, isoparaffin and a surfactant (sorbitan sesquioleate: at 4% weight ratio to isoparaffin) were added in a beaker and stirred under heating by using a stirrer. In the stirred state, the slurry prepared as described above was added little by little into the beaker. By the stirring, fine liquid droplets comprising a slurry which does not confine the oil droplet particle to the inside were formed in the beaker.

The treatments so far were performed under a circumstance of keeping the temperature at 40° C. or higher so that agar as the binder was not hardened.

Then, the beaker was cooled to cause gelling the fine liquid droplets formed as described above. The gelled droplets were recovered and, after solvent cleaning with ethanol, vacuum-dried under a reduced pressure, followed by a calcination treatment at 700° C.

The obtained ceramic particles were classified into the average particle diameters of 80 μm, 60 μm, and 40 μm, which are used respectively as samples of Comparative Examples 1, 2, and 3.

Then, for the samples prepared in Example 1 and Comparative Examples 1 to 3, a test for protein separation performance was performed.

### (Test for Protein Separation Performance)

The test for protein separation performance was carried out by using a high performance liquid chromatograph (Lachorm L-7000, manufactured by Hitachi Ltd.). An eluate, a protein sample, an empty column, a filler slurry, test conditions, etc. were as described below.

For the eluate, 1 mM sodium phosphate buffer and 400 mM sodium phosphate buffer were used. Each of the eluates was adjusted to be pH 6.8. As the protein sample, albumin, ribosome, and cytochrome-C were used, and protein sample solutions containing each proteins by 0.03 mM were used. For the solvent for the protein sample solution, 1 mM sodium phosphate buffer was used. For the empty column, a stainless steel column of 2 mmφ×150 mm was used.

As the filler slurry, 0.3 g of each of various kinds of fillers diluted with 400 mM sodium phosphate buffer to be a particle concentration of 10 wt % was used. In the packing to a column, an empty column with attachment of a packer was disposed to a high performance liquid chromatograph, to which the filler slurry was charged and filled by flowing 1 mM sodium phosphate buffer at a flow rate of 2 mM/min.

For the evaluation of the protein separation performance, the eluate was caused to flow at a flow rate of 1 mL/min. After flowing the 1 mM sodium phosphate buffer as the eluate for 5 min, it was linearly changed from 1 mM to 200.5 mM (1 mM (50%)+400 mM (50%)) for 15 min.

In view of the result for the separation performance in Comparative Example 1 to Comparative Example 3, it was confirmed that the protein separation performance was improved more as the particle diameter was smaller. Namely, it was recognized that peaks for albumin and ribosome were separated more as the particle diameter was smaller. This is considered to be attributable to that the specific surface area was increased due to the decrease of the particle diameter and the area of contact with the eluate was increased. It was confirmed that albumin and lysozyme were not separated in Comparative Example 1 where the average particle diameter was 80 μm.

On the contrary, it was confirmed in Example 1 that peaks of the albumin and lysozyme were separated greatly although the average particle diameter was identical with that of Comparative Example 1.

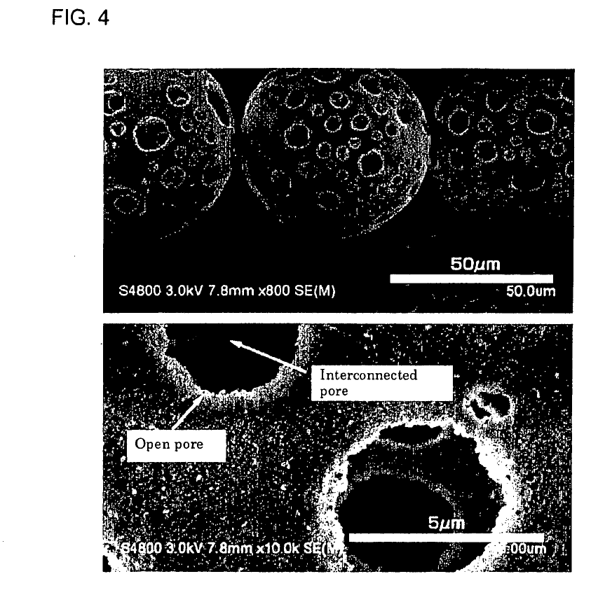

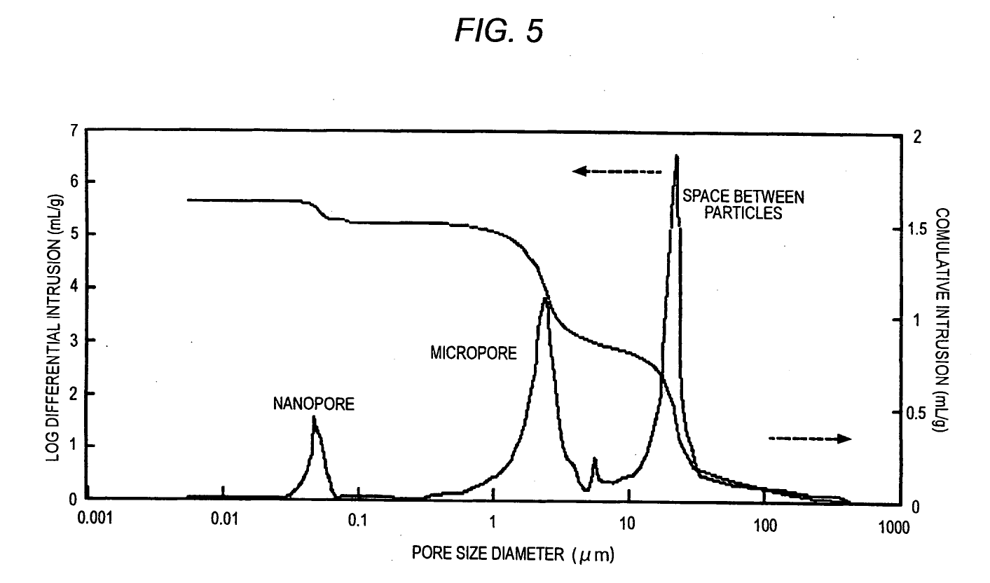

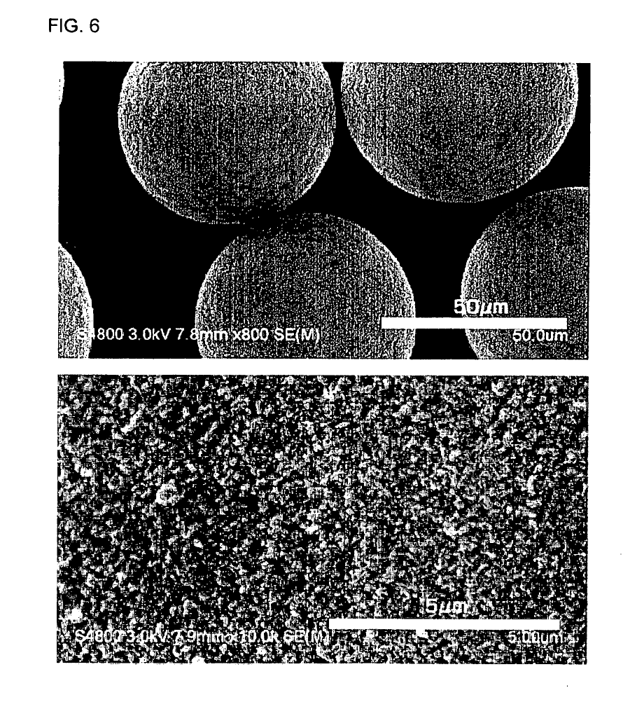

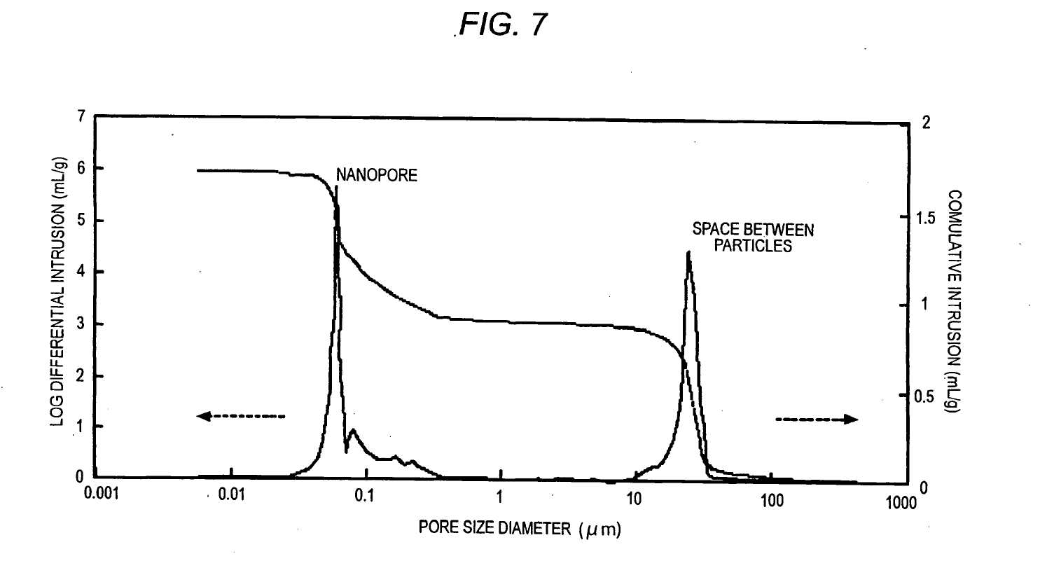

FIG. 4 shows an SEM photograph for ceramic particles prepared in Example 1 and FIG. 5 shows the result of analysis for the ceramic particles produced in Example 1 by a mercury porosimeter, respectively. Furthermore, FIG. 6 shows an SEM photograph for ceramic particles produced in Comparative Examples 1 to 3, and FIG. 7 shows the result of analysis for the ceramic particles manufactured in Comparative Example 1 to Comparative Example 3 by a mercury porosity, respectively.

It can be confirmed as shown in FIG. 4 and FIG. 5 that the ceramic particles produced in Example 1 have two types of peaks that is a peak in the pore size distribution with 300 nm or more and 20 μm or less and a peak in the pore size distribution in 200 nm or less. The peak at the most right end in FIG. 5 detects a clearance between particles by the mercury porosimeter, which is different from the peak of the ceramic particles of the present invention. On the contrary, as shown in FIG. 6 and FIG. 7, in the ceramic particles manufactured in Comparative Examples 1 to 3, a peak in the pore size distribution of 300 nm or more and 20 μm or less was not present and it was confirmed a result that only the peak in the pore size distribution of 200 nm or less was present.

When the specific surface area was measured for skeleton part of the ceramic particles in Example 1 and Comparative Examples 1 to 3, the specific surface area was 30 m²/g for each of them.

### Example 2

Ceramic particles were produced by the same method as in Example 1 except for using an alumina powder instead of the hydroxyapatite powder.

As a result, in the same manner as in Example 1, ceramic particles could be obtained, in which two pore size distributions were present in the measurement by a mercury porosimeter, within a range of 300 nm or more and 20 μm or less and within a range of 200 nm or less.

### Example 3

Ceramic particles were produced by the same method as in Example 1 except for using a silica powder instead of the hydroxyapatite powder in Example 1.

As a result, in the same manner as in Example 1, ceramic particles could be obtained, in which two pore size distributions were present in the measurement by a mercury porosimeter, within a range of 300 nm or more and 20 μm or less and within a range of 200 nm or less.

### Example 4

Ceramic particles were produced by the same method as in Example 1 except for using a mullite powder instead of the hydroxyapatite powder.

As a result, in the same manner as in Example 1, ceramic particles could be obtained, in which two pore size distributions were present in the measurement by a mercury porosimeter, within a range of 300 nm or more and 20 μm or less and within a range of 200 nm or less.

### Example 5

Ceramic particles were produced by the same method as in Example 1 except for using a zirconia powder instead of the hydroxyapatite powder.

As a result, in the same manner as in Example 1, ceramic particles could be obtained, in which two pore size distributions were present in the measurement by a mercury porosimeter, within a range of 300 nm or more and 20 μm or less and within a range of 200 nm or less.

### Example 6

Ceramic particles were produced by the same method as in Example 1 except for using a silicon carbide powder instead of the hydroxyapatite powder.

As a result, in the same manner as in Example 1, ceramic particles could be obtained, in which two pore size distributions were present in the measurement by a mercury porosimeter, within a range of 300 nm or more and 20 μm or less and within a range of 200 nm or less.

An example according to the second embodiment is described specifically.

### Example 7

To an aqueous agar solution formed by adding agar to pure water at a weight ratio of 0.5%, a hydroxyapatite powder was mixed at a weight ratio of 30% based on the aqueous agar solution, and ammonium polyacrylate was added as a dispersant at a 5% weight ratio based on the hydroxyapatite powder. They were mixed in a ball mill for 10 hr or more to prepare a slurry containing hydroxyapatite.

Then, 1% polyoxyethylene sorbitan monooleate based on pure water and 30% isoparaffin based on pure water were added respectively to the obtained slurry, and then they were stirred by using a stirrer. Isoparaffin was emulsified in the slurry by the stirring to form an oil droplet particle, and an apatite slurry in which the oil droplet particles were dispersed was prepared.

Then, isoparaffin and a surfactant (sorbitan sesquioleate: at 4% by weight ratio based on isoparaffin) were charged in a beaker and stirred by using a stirrer under heating. The apatite slurry in which the thus prepared oil droplet particles were dispersed was added little by little in the stirred state into the beaker. By the stirring, fine liquid droplets comprising a slurry confining the oil droplet particles in the inside were formed in the beaker.

The treatments so far were performed under a circumstance of keeping the temperature at 40° C. or higher so that agar as the binder is not solidified.

Then, the beaker was cooled and gelling fine liquid droplets were formed as described above. Then, the gelled fine droplets were recovered and, after solvent cleaning with ethanol, vacuum-dried under a reduced pressure and subjected to a baking treatment at 700° C.

The obtained ceramic particles were classified into an average particle size of 80 μm as a sample of Example 7.

### Comparative Examples 4 to 6

To an aqueous agar solution formed by adding agar to pure water at a weight ratio of 0.5%, a hydroxyapatite powder was mixed at a weight ratio of 30% based on the aqueous agar solution, and ammonium polyacrylate was added as a dispersant at a 5% weight ratio based on the hydroxyapatite powder. They were mixed in a ball mill for 10 hr or more to prepare a slurry containing hydroxyapatite.

Then, without forming the oil droplet particles as shown in Example 7, isoparaffin and a surfactant (sorbitan sesquioleate:at 4% weight ratio to isoparaffin) were charged in a beaker and stirred under heating by using a stirrer. In the stirred state, the slurry prepared as described above was added little by little into the beaker. By the stirring, fine liquid droplets comprising a slurry in which the oil droplet particles were not confined were formed in the beaker.

The treatments up so far were performed under a circumstance of keeping the temperature at 40° C. or higher so that agar as the binder was not solidified.

Then, the beaker was cooled and gelling fine liquid droplets were formed as described above. Then, the gelled fine droplets were recovered and, after solvent cleaning with ethanol, vacuum-dried under a reduced pressure and subjected to a baking treatment at 700° C.

The obtained ceramic particles were classified into the average particle size of 80 μm, 60 μm and 40 μm as samples of Comparative Examples 4, 5 and 6.

Then, for the samples prepared in Example 7 and Comparative Examples 4 to 6, a test for protein separation property was performed.

### Test for Protein Separation Property

The test for protein separation property was performed by using a high performance liquid chromatograph (Lachorm L-7000, manufactured by Hitachi Ltd.), an eluate, a protein sample empty column, a filler slurry, and test conditions are as described below.

For the eluate, 1 mM sodium phosphate buffer, and 400 mM sodium phosphate buffer were used. Each of the eluates was adjusted to pH 6.8. For the protein sample, albumin ribosome, cytochrome-C were used and protein sample solutions containing each protein of 0.03 mM were used. As the solvent for the protein sample solution, 1 mM sodium phosphate buffer was used. As the empty column, a stainless steel column of 2 mmφ×150 mm was used.

For the filler slurry, those prepared by diluting 0.3 g of each of various filler with 400 mM sodium phosphate buffer at a particle concentration of 10 wt % were used. The filler material slurry was filled into the column by disposing an empty column with a packer to a high performance liquid chromatograph and a filler slurry was charged therein. At a flow rate of 2 mL/min to pack the column, 1 mM sodium phosphate buffer was made to flow.

For the evaluation of the protein separation property, the eluate was made to flow at a flow rate of 1 mL/min. After flowing 1 mM sodium phosphate buffer as an eluate for 5 min, it was linearly changed from 1 mM to 200.5 mM (1 mM(50%)+400 mM(50%)) for 15 min.

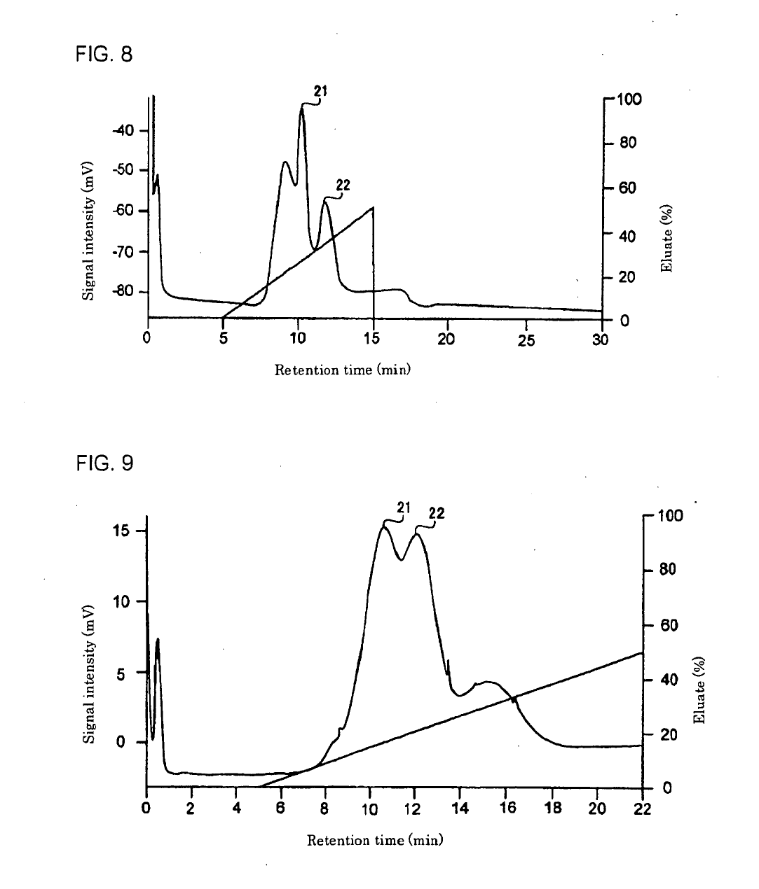

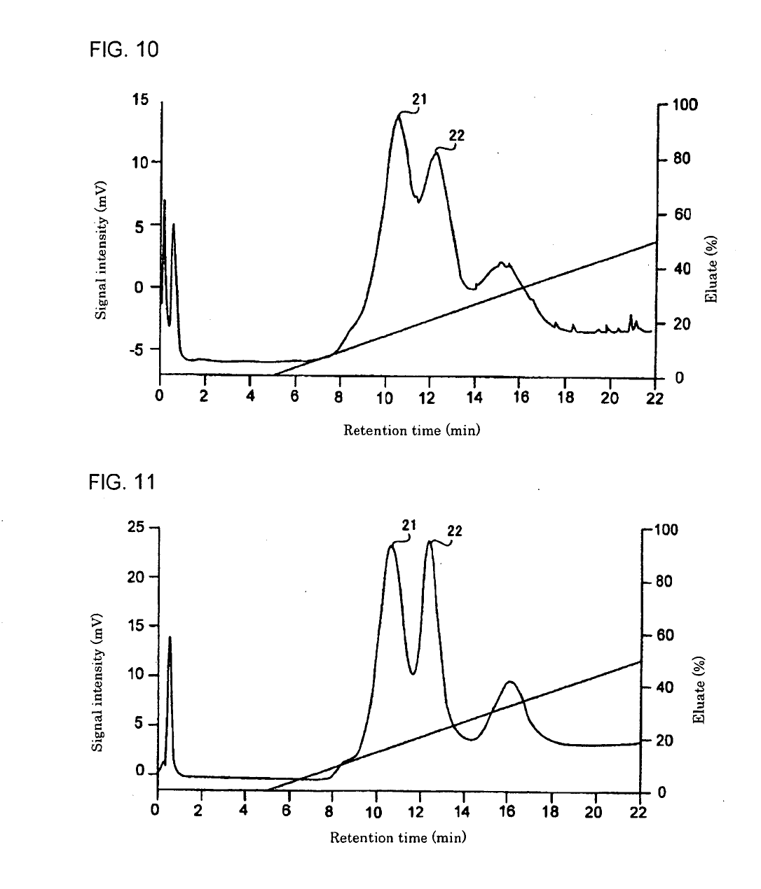

FIG. 8 shows the result of evaluation for the separation property in Example 7 while FIG. 9 to FIG. 11 show the result of the evaluation for the separation property in each of the Comparative Examples, respectively.

In view of the results from Comparative Example 4 to Comparative Example 6 (FIG. 9 to FIG. 11), it can be seen that the protein separation property is more excellent as the particle size is smaller. Namely, it can be seen that peaks for albumin 21 and ribosome 22 are separated more as the particle size is smaller. This is considered that the specific surface area was increased due to the reduction of particle size and the area of contact with the eluate was increased. In Comparative Example 4 for the average particle size of 80 μm (FIG. 9), it can be confirmed that albumin 21 and lisotime 22 were not separated.

On the contrary, in Example 7 (FIG. 8), it can be confirmed that peaks for albumin 21 and lisotime 22 are separated remarkably although the average particle size is identical with that of Comparative Example 4.

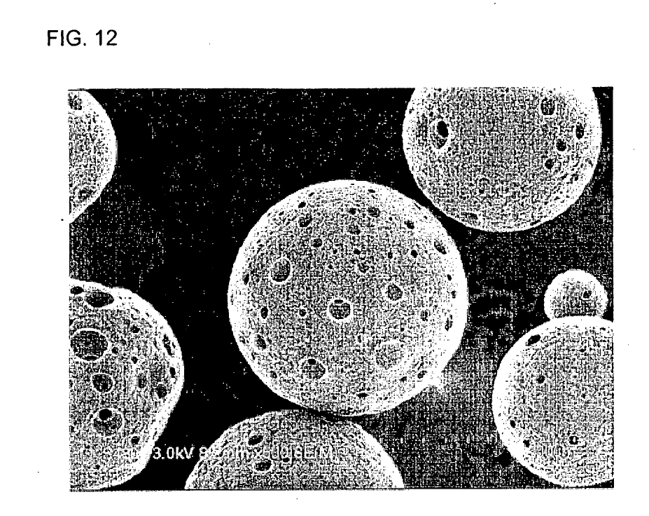

FIG. 12 shows an SEM photograph for ceramic particles prepared in Example 7 before classification to an average particle size of 80 μm.

As shown in FIG. 12, in the ceramic particles produced in Example 7, it can be confirmed that a plurality of open pores having an average pore size of 1 μm or more and 30 μm or less and having the pore diameter for the opening part and the communication part of 500 nm or more and 20 μm or less are formed from the outer surface to the inside thereof. Namely, it is estimated that the result of the test for the protein separation property is due to a plural number of open pores formed in the ceramic particle. In the ceramic particles of Comparative Examples 4 to 6, a plural number of open pores as confirmed for Example 1 were not confirmed. When the specific surface area was measured for the skeleton part of the ceramic particles in Example 7 and Comparative Examples 4 to 6, the specific surface area was 30 m²/g, respectively.

### Comparative Example 7

Ceramic particles were produced in the same method as in Example 7 except for forming smaller oil droplet particles than those of Example 7 were formed by controlling the amount of isoparaffin used and the intensity of the stirrer in forming the oil droplet particles.

When the test for protein separation property was performed in the same manner as in Example 7 for the sample manufactured by Comparative Example 7, the protein separation property at a level which is identical with that of Comparative Example 5 was confirmed. When the open pore of the ceramic particle was evaluated in this case, the pore size for the opening part and the communication part of the open pores was 200 nm or less respectively, and ceramic particles with the pore size for the opening part and the communication part exceeding 300 nm were not confirmed.

### Example 8

Ceramic particles were manufactured by the same method as in Example 7 except for forming larger oil droplet particles than those in Example 7 by controlling the amount of isoparaffin used and the intensity of the stirrer in forming the oil droplet particles and controlling the intensity of the stirrer in forming the fine liquid droplets in order to obtain the larger particle size of the ceramic particles than that of Example 7. Then, the obtained ceramic particles were classified into an average particle size of 200 μm as a sample for Example 8.

When the test for protein separation property was performed for the sample produced in Example 8 by the same method as in Example 7, the protein separation property at a level which is identical with that in Example 1 was confirmed. When the open pore of the ceramic particles was evaluated in this case, a plural number of open pores with an average pore size of 25 μm or more and 50 μm or less and having the pore size for the opening part and the communication part of 10 μm or more and 20 μm or less were confirmed.

### Comparative Example 8

Ceramic particles were produced in the same method as in Example 8 except for forming further larger oil droplet particles than those of Example 8 were formed by controlling the amount of isoparaffin used and the intensity of the stirrer in forming the oil droplet particles.

When the obtained ceramic particles were confirmed by SEM photograph, the particle size of the obtained ceramic particles was extremely small in comparison of those in Example 8. The ceramic particle was tipped or cracked in some places, and many particles which were broken per se were confirmed. When the open pores of the broken ceramic particles were evaluated, many particles with the pore size for the opening part and the communication part of the open pores of more than 20 μm were confirmed.

### Example 9

Ceramic particles were produced by the same method as in Example 7 except for using an alumina powder instead of the hydroxyl apatite powder.

As a result, in the same manner as in Example 7, ceramic particles having a plural number of open pores with an average pore size of 500 nm or more and 40 μm or less and a pore size for the opening part and the communication part of 300 nm or more and 10 μm or less from the outer surface to the inside thereof as shown in FIG. 12 could be obtained.

### Example 10

Ceramic particles were produced by the same method as in Example 7 except for using a silica powder instead of the hydroxyl apatite powder.

As a result, in the same manner as in Example 7, ceramic particles having a plurality of open pores with an average pore size of 500 nm or more and 40 μm or less and a pore size for the opening part and the communication part of 300 nm or more and 10 μm or less from the outer surface of the inside thereof as shown in FIG. 12 could be obtained.

### Example 11

Ceramic particles were produced by the same method as in Example 7 except for using a mullite powder instead of the hydroxyl apatite powder.

As a result, in the same manner as in Example 7, ceramic particles having a plurality of open pores with an average pore size of 500 nm or more and 40 μm or less and a pore size for the opening part and the communication part of 300 nm or more and 10 μm or less from the outer surface to the inside thereof as shown in FIG. 12 could be obtained.

### Example 12

Ceramic particles were manufactured by the same method as in Example 7 except for using a zirconia powder instead of the hydroxyl apatite powder.

As a result, in the same manner as in Example 7, ceramic particles having a plural number of open pores with an average pore size of 500 nm or more and 40 μm or less and a pore size for the opening part and the communication part of 300 nm or more and 10 μm or less from the outer surface to the inside thereof as shown in FIG. 12 could be obtained.

### Example 13

Ceramic particles were produced by the same method as in Example 7 except for using a silicon carbide powder instead of the hydroxyl apatite powder.

As a result, in the same manner as in Example 7, ceramic particles having a plurality of open pores with an average pore size of 500 nm or more and 40 μm or less and a pore size for the opening part and the communication part of 300 nm or more and 10 μm or less from the outer surface to the inside thereof as shown in FIG. 12 could be obtained.

### Example 14

Ceramic particles were produced by the same method as in Example 7 except for using an alumina powder, a silica powder, a mullite powder, a zirconia powder, and a silicon carbide powder respectively, forming larger oil droplet particles than those in Example 7 by controlling the amount of use of isoparaffin and the intensity of the stirrer in forming the oil droplet particles and controlling the intensity of the stirrer in forming the fine liquid droplet in order to obtain larger particle size of the ceramics particles than that of Example 7. Then, the obtained ceramic particles were classified respectively into an average particle size of 200 μm as samples for Example 14.

When the open pores of the obtained ceramic particles for each of the powders were evaluated, a plural number of open pores with the average pore size of 25 μm or more and 50 μm or less and the pore size for the opening part and the communication part of 10 μm or more and 20 μm or less were confirmed from the outer surface to the inside thereof for all of the ceramic particles.

The ceramic particles of Example 1 to Example 14 produces as described above can be used suitably, for example, to catalyst carriers.

The present invention is not limited to the embodiments described above and can be carried out with various modifications within a range which is included in the scope of the present invention.

This patent application is based on Japanese Patent Application No. 2008-188675 filed on Jul. 22, 2008, Japanese Patent Application No. 2008-251238 filed on Sep. 29, 2008, Japanese Patent Application No. 2008-275836 filed on Oct. 27, 2008 and Japanese Patent Application No. 2009-144502 filed on Jun. 17, 2009 and the contents thereof are incorporated herein by reference.

What is claimed is:

1. A ceramic particle:
having an average particle diameter of 5 μm or more and 5 mm or less and a plurality of open pores formed at the outer surface; and
having two pore size distributions in the measurement by a mercury porosimeter.

2. The ceramic particle according to claim 1, wherein the two pore size distributions include a first pore size distribution having a peak within a range from 300 nm or more and 20 μm or less and a second pore size distribution having a peak within a range of 200 nm or less.

3. A ceramic particle in which a plural number of open pores are formed at the outer surface, wherein
the average pore size of the open pores is 500 nm or more and 50 μm or less;
the pore size for the opening part of the open pore on the side of the outer surface is 300 nm or more and 20 μm or less; and
a skeleton part which forms the open pores comprises a porous body.

4. A ceramic particle in which a plural number of open pores are formed at the outer surface, wherein
the open pore has a surface open pore formed at the outer surface with an average pore size of 500 nm or more and 50 μm or less and a internal open pore formed in communication with the inner wall surface of the surface open pore with an average pore size of 500 nm or more and 50 μm or less;
the pore size for the opening part of the surface open pore on the side of the outer surface and the pore size for the communication part between the surface open pore and the internal open pore is 300 nm or more and 20 μm or less; and
the skeleton part which forms the open pores comprises a porous body.

5. The ceramic particle according to claim 3, wherein the open pore is formed in communication from one outer surface to the other outer surface of the ceramic particle.

6. The ceramic particle according to claim 4, wherein the open pore is formed in communication from one outer surface to the other outer surface of the ceramic particle.

7. A ceramic particle according to claim 1, which comprises any one of inorganic oxides, silicon carbides, boron carbides, and silicon nitrides.

8. A ceramic particle according to claim 2, which comprises any one of inorganic oxides, silicon carbides, boron carbides, and silicon nitrides.

9. A ceramic particle according to claim 3, which comprises any one of inorganic oxides, silicon carbides, boron carbides, and silicon nitrides.

10. A ceramic particle according to claim 4, which comprises any one of inorganic oxides, silicon carbides, boron carbides, and silicon nitrides.

11. A ceramic particle according to claim 5, which comprises any one of inorganic oxides, silicon carbides, boron carbides, and silicon nitrides.

12. A ceramic particle according to claim 6, which comprises any one of inorganic oxides, silicon carbides, boron carbides, and silicon nitrides.

13. A method for producing a ceramic particle including a step of:
adding a first oil and a hydrophilic surfactant to a slurry (W) containing a ceramic powder, a binder, a dispersant, and pure water and
providing shear stress to the first oil to form an oil droplet particle (O) comprising the first oil in order to prepare an O/W emulsion in which the oil droplet particles (O) are dispersed in the slurry (W);
a step of:
adding the O/W emulsion to a second oil (O) containing an oleophilic surfactant and
providing shear stress to the O/W emulsion to form a fine liquid droplet (O/W) comprising a slurry in which the oil droplet particles (O) are confined in the inside thereof in order to prepare an O/W/O emulsion in which the fine liquid droplets (O/W) are dispersed in the second oil (O); and
a step of baking the fine liquid droplet (O/W).
